(19) United States
(12) Patent Application Publication
(10) Pub. No.: US 2008/0093488 A1
(43) Pub. Date: Apr. 24, 2008

(54) Shredder

(75) Inventors: Michael Kent, Cumberland, RI (US); Daniel A. Barry, Berlin, MA (US); Connie Walsh, Wellesley, MA (US); Aron Abramson, Brooklyn, NY (US); Charles Sued, Brooklyn, NY (US); Bai Shuhui, Jinjiang City (CN)

Correspondence Address: WOLF GREENFIELD & SACKS, P.C., 600 ATLANTIC AVENUE, BOSTON, MA, 02210-2206, US

(73) Assignee: Staples The Office Superstore, LLC, Framingham, MA (US)

(21) Appl. No.: 11/583,376

(22) Filed: Oct. 19, 2006

(51) Int. Cl. B02C 23/04

(52) U.S. Cl. 241/100

(57) ABSTRACT

A shredder including a shredding mechanism and a housing at least partially enclosing the shredding mechanism is provided. The shredder further includes a receptacle to which the housing is removably coupled, that receives and contains shredded material. The shredder may include a handle movably attached to the housing, to enable removal of the housing from the receptacle. The shredder may also include a flap, movably coupled to the housing, positioned to protect a user from the shredding mechanism during removal of the housing from the receptacle.

### FIELD OF INVENTION

The present application relates to a shredder for shredding items, such as, but not limited to papers, credit cards, compact discs (CD's), digital video discs (DVD's) and various types of junk mail.

### BACKGROUND OF INVENTION

There is an increasing demand for shredding documents such as those that contain any personal or confidential information. Identity theft is a growing problem and people are becoming more concerned with limiting the general availability and access to this type of information to others.

Various types of shredders, commonly referred to as paper shredders, are currently on the market to shred these documents. People routinely shred documents such as financial statements, medical records, credit cards and employee files. Shredding documents is also a common practice in certain legal and government circumstances. Other items, such as credit card applications and junk mail, are also shred rather than just thrown in the trash to further protect against identity theft.

### SUMMARY OF INVENTION

In one aspect of the invention, a shredder is disclosed. The shredder includes a shredding mechanism, a housing at least partially enclosing the shredding mechanism, and a receptacle to which the housing is removably coupled, that receives and contains shredded material. The shredder may further include a handle coupled to the housing, where the handle is movable between at least a first position and a second position with respect to the housing. When the handle is in the second position, the shredding mechanism is disabled and the housing may be removed safely from the receptacle.

In another aspect of the invention, a shredder is disclosed. The shredder includes a shredding mechanism, a housing at least partially enclosing the shredding mechanism, and a receptacle to which the housing is removably coupled, that receives and contains shredded material. The shredder may further include a flap positioned on a side of the housing adjacent the shredding mechanism, where the flap is movable between a closed position in which the flap covers the shredding mechanism and an open position in which an opening is provided between the shredding mechanism and the receptacle. The shredder may include a cam movable with the flap between at least a first position and a second position. When the cam is in the first position, the flap is in the closed position. The shredder may also include a detent positioned on the receptacle, arranged to move the cam to the second position when the housing is coupled to the receptacle.

In yet another aspect of the invention, a shredder is disclosed. The shredder includes a shredding mechanism, a housing at least partially enclosing the shredding mechanism, and a receptacle, to which the housing is removably coupled, that receives and contains shredded material. The shredder may further include a handle, movably attached to the housing, to enable removal of the housing from the receptacle, and a flap, movably coupled to the housing. The flap is positioned to protect a user from the shredding mechanism during removal of the housing from the receptacle.

### BRIEF DESCRIPTION OF DRAWINGS

The foregoing and other items and advantages of the present invention will be appreciated more fully from the following drawings, wherein like reference characters designate like features, in which:

FIG. 1 is a perspective view of one embodiment of a shredder;

FIG. 2 is a front view of the embodiment illustrated in FIG. 1;

FIG. 3 is a side view of the embodiment illustrated in FIG. 1;

FIG. 4 is a perspective view of one embodiment of a shredder with the handle in a raised position;

FIG. 5 is a side view of the embodiment illustrated in FIG. 4;

FIG. 6 is a side view of a housing with a flap according to one embodiment;

FIG. 7 is a perspective view of the underside of a housing with a flap illustrated in a closed position;

FIG. 8 is a perspective view of the underside of a housing with a flap illustrated in an open position;

FIG. 9 is a perspective view of the housing according to one embodiment;

FIG. 10 is a perspective view of the housing illustrated in FIG. 9 with a flap illustrated in an open position; and

FIG. 11 is a perspective view of a receptacle according to one embodiment.

### DETAILED DESCRIPTION

Aspects of the invention are directed to a shredder used to shred documents or other items which may contain confidential or personal information. The shredder includes a shredding mechanism which may be configured to destroy information in several types of media, for example, but not limited to, paper, CD's, DVD's and/or credit cards.

Certain embodiments of the present invention are directed to a shredder having a handle coupled to the shredding mechanism, making it easier for a user to remove the shredding mechanism from a receptacle which holds the shredded material. As discussed below, the position of the handle may control whether or not the shredding mechanism is operable.

Other embodiments of the present invention are directed to a shredder having a shredding mechanism at least partially enclosed by a housing, with a protective flap positioned on a side of the housing. The flap may be positioned adjacent the shredding mechanism to shield the shredding mechanism when the shredder is not actively in use. The position of the flap may also control whether or not the shredding mechanism is operable.

Turning now to the drawings, it should be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one figure, and/or may also encompass embodiments combining components illustrated in multiple different drawings.

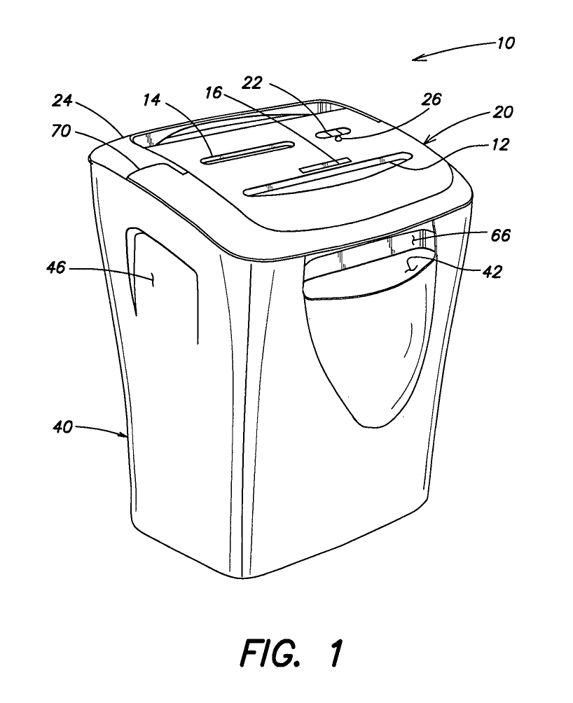

In FIG. 1, a shredder 10 is illustrated. The shredder 10 includes a shredding mechanism 30 (not shown in FIG. 1, see FIG. 8) which is at least partially enclosed within a housing 20. In some embodiments, such as the embodiment illustrated in FIG. 1, the shredding mechanism 30 is completely enclosed within the housing 20. The shredding mechanism may include a plurality of rotating blades configured to shred an item, such as a document. However, it should be appreciated that the present invention is not limited to a particular type of shredding mechanism configuration.

A receptacle 40 is positioned adjacent the housing 20 to contain material shredded by the shredder mechanism 30. As shown, the housing 20 may fit on top of the receptacle 40 and at least a portion of the housing 20 may be recessed within the receptacle 40.

The housing 20 includes at least one opening 12, 14, 16 for inserting items to be shred into the shredding mechanism 30. In the embodiment of FIG. 1, there is a first opening 12 configured to receive items, such as various types of paper documents, envelopes, etc., to be shred. A second smaller opening 14 may be provided specifically for receiving other items to be shred, such as discs (i.e. CD's and DVD's), and a third even smaller opening 16 may further be included for receiving even smaller items to be shred, such as credit cards and card keys.

Items to be shred are fed into one of these openings 12, 14, 16. This may automatically trigger the shredding mechanism 30 to start which pulls the item into the shredder 10. As described in greater detail below, the housing 20 includes another opening 60 (see FIG. 8) on a side of the housing adjacent the shredding mechanism 30. In the embodiment illustrated in FIG. 8, the opening 60 is located on the underside of the housing 20. As the blades of the shredding mechanism 30 cut the item, the shredded pieces of the item fall through the opening 60 and into the receptacle 40.

Periodically, the shredded material in the receptacle 40 must be discarded. This may be accomplished by removing the housing 20 which includes the shredding mechanism 30 from the receptacle 40. Once removed, the shredded material may be discarded, and thereafter the housing 20 with the shredding mechanism 30 is placed back on the receptacle 40.

Applicants have recognized that it may be difficult to remove the housing including the shredding mechanism 30 from the receptacle 40. Typically, the majority of the weight of a shredder 10 is within the shredding mechanism 30 itself. Due to the weight imbalance, it may be hard to remove the shredding mechanism 30 from a lighter receptacle 40.

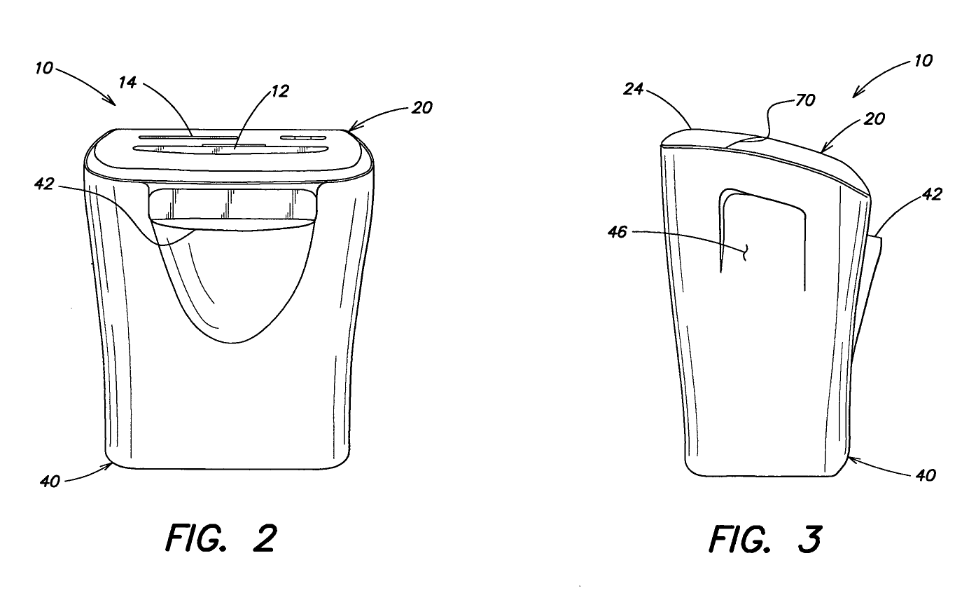

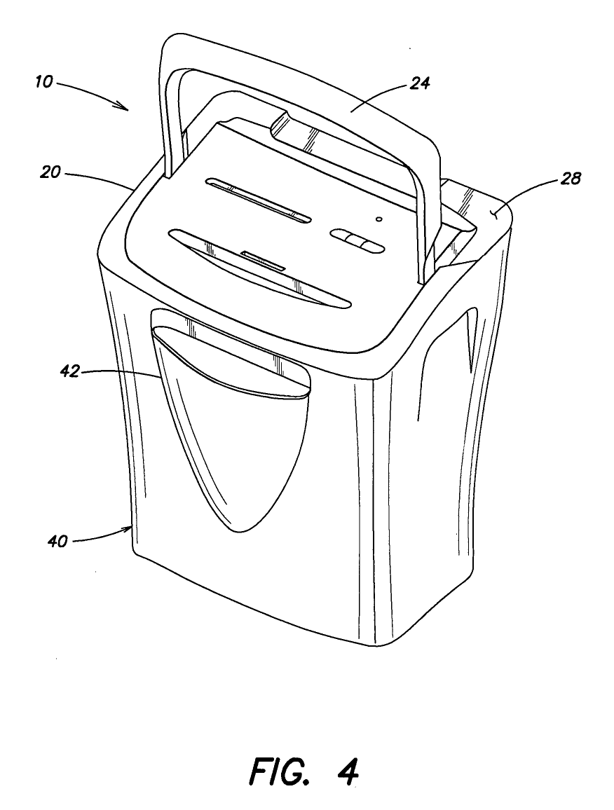

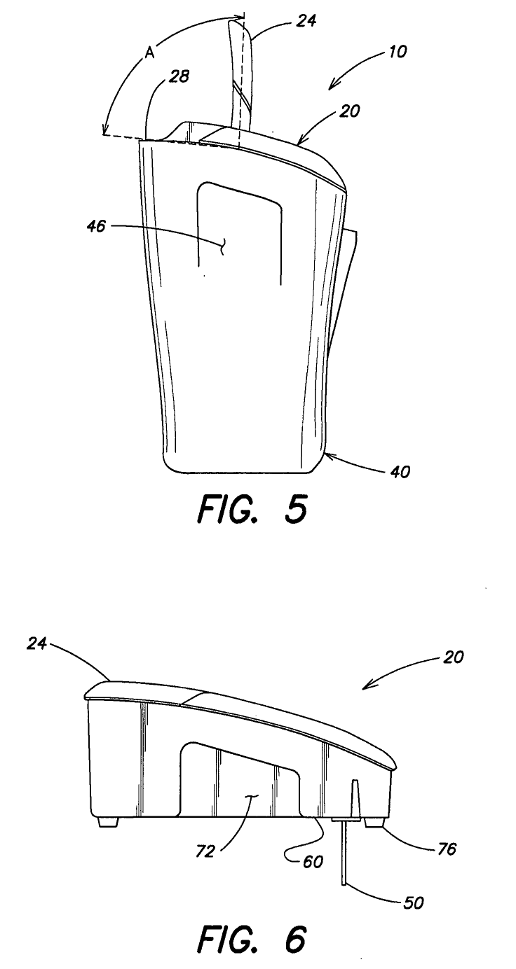

Therefore, aspects of the invention are directed to a housing 20 enclosing the shredding mechanism 30 where a handle 24 is coupled to the housing 20. As shown in FIGS. 1-5, the handle 24 may be movable between at least a first position and a second position with respect to the housing 20. The handle 24 may be configured to be grasped by a user when the handle 24 is in the second position (FIGS. 4 and 5) to remove the housing 20 from the receptacle 40. Other aspects of the handle 24 are described in more detail below.

To assist the user with moving the entire shredder 10 or just the receptacle 40, side handles 46 may be provided on the receptacle 40. As shown in FIGS. 1-5, the side handles 46 may be molded into the sidewalls of the receptacle, as recesses for example.

However, in other embodiments, side handles 46 may be configured differently, and in further embodiments, side handles are not included, as the present invention is not so limited.

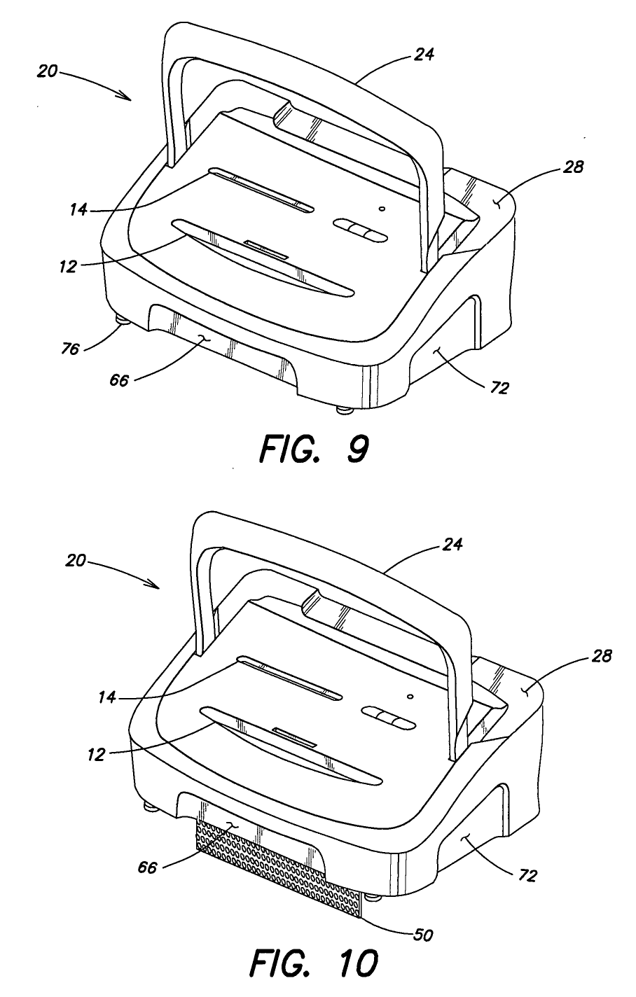

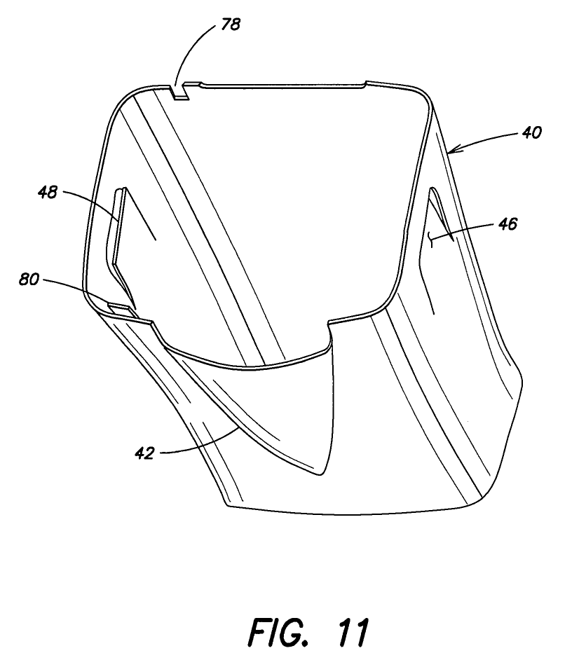

It should be understood that in addition to holding shredded material, the receptacle 40 may also be used more generally as a trash can. Therefore, in one embodiment, the receptacle may include an opening 42 to permit things to be thrown into the receptacle 40, without being fed through the shredding mechanism 30. The opening 42 may be formed into a sidewall of the receptacle 40. As shown in FIGS. 1 and 11, the opening 42 may be created with a notch in the top portion of the receptacle 40. Furthermore, as illustrated more clearly in FIGS. 1 and 3, portions of the receptacle around the opening 42 may bow outwardly to make it easier to fit items into the receptacle 40. Additionally, the housing 20 may include recessed portions 66 (see FIGS. 1, and 7-9) adjacent the opening 42 to make it easier to fit items through the opening 42. However, it should be appreciated that not all embodiments of the present invention require that the shredder 10 include an opening 42 such that the shredder may be used as a trash can, as the invention is not limited in this respect.

Turning to FIGS. 4 and 5, a shredder 10 is illustrated with the handle 24 in an upwardly extending configuration. In one embodiment, the upwardly extending handle configuration corresponds to the second handle position discussed above. In this position, the housing 20 and shredding mechanism 30 may be safely removed from the receptacle by grasping the handle 24 to pull the housing 20 away from the receptacle 40. As illustrated in this particular embodiment, the housing 20 may include a recessed portion 28 and the handle 24 is adapted to fit within at least a portion of the recessed portion 28 when the handle 24 is in the first handle position (shown in FIGS. 1-3). In contrast, in the second position (shown in FIGS. 4-5), the handle 24 extends out of the recessed portion 28.

As shown, the recessed portion 28 may be substantially U-shaped and may extend around the outer perimeter of the housing 20. In this embodiment, the size and shape of the recessed portion 28 matches the size and substantial U-shape of the handle 24. In other embodiments, the handle 24 and recess 28 may be sized and shaped differently.

Furthermore, in the embodiment shown in FIGS. 1 and 3, when the handle 24 is in the first position, the handle 24 is flush with portions of the housing 20 at the transition point 70. It should be recognized that the handle 24 may be configured to form a smooth contour with other portions of the housing 20.

In the embodiments illustrated in FIGS. 1-5, the handle 24 is rotatable with respect to the housing 20. In one embodiment, the handle 24 is rotatable between the first position and the second position, and the first and second positions are spaced apart at an angle A of approximately 90° (see FIG. 5). In other embodiments, the first and second positions may be spaced apart at another angle B (not shown), such as between approximately 45° and 135°.

It should be appreciated that in other embodiments, the handle 24 may be movable with respect to the housing 20 in other ways. For example, the shredder 10 may be configured for translational movement of the handle 24 with respect to the housing 20. In yet other embodiments, both rotational and translational movement of the handle 24 with respect to the housing 20 may be present, as the invention is not so limited.

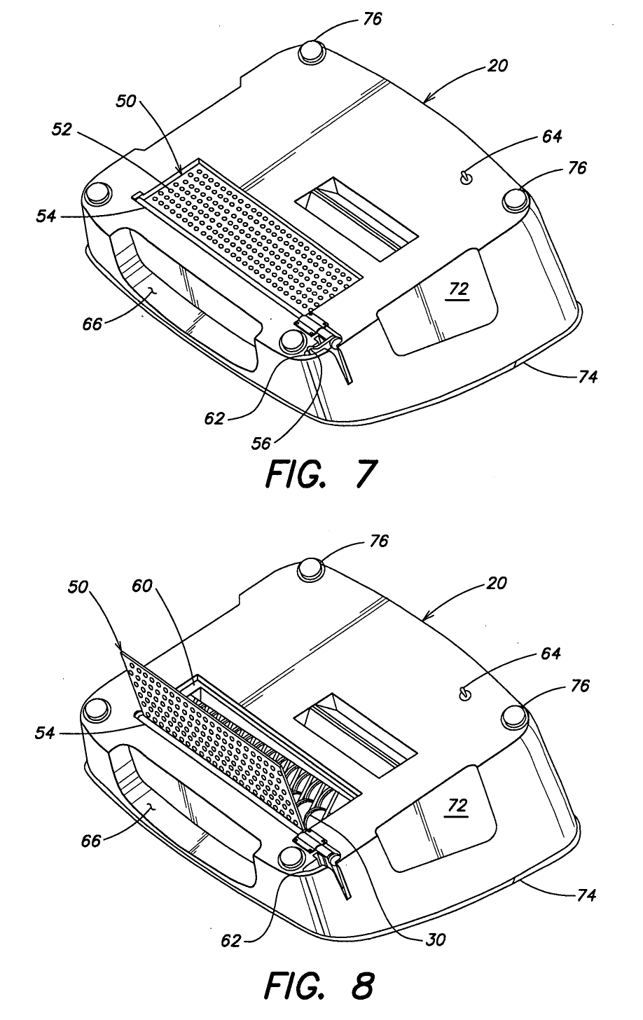

Moving to FIG. 6, a side view of a shredder housing 20 according to one embodiment of the present invention is illustrated. In this embodiment, the handle 24 is in the first position, lying against a portion of the housing 20. A flap 50 is positioned on a side of the housing 20. This flap 50 is positioned adjacent the shredding mechanism 30 to selectively shield the shredding mechanism 30 when the shredder 10 is not actively in use. In the embodiment shown in FIG. 6, the flap 50 is in an open position which provides a pathway or opening 60 (also see FIG. 8) between the shredding mechanism 30 and the receptacle 40 so that items which pass through the shredding mechanism fall directly into the receptacle. As shown in FIG. 7, the flap 50 may alternatively be in a closed position where the flap 50 covers the opening 60 and shields the shredding mechanism 30.

Additional details regarding certain embodiments of the flap 50 on the housing 20 are shown in FIGS. 7 and 8. The flap 50 is in a closed position in FIG. 7. In FIG. 8, the flap 50 is in an open position.

The flap 50 may protect a user from the shredding mechanism during removal of the housing 20 from the receptacle 40. Additionally, the flap 50 may also help to prevent the shredding mechanism from damaging a surface on which the housing 20 is placed. As discussed above, to empty shredded material from the receptacle 40, the housing 20 is removed from the receptacle, and the receptacle 40 may then be emptied like a trash can. During this process, the housing 20 with the shredding mechanism 30 inside may be set down on a surface, such as a countertop or floor. The positioning of a flap 50 over the shredding mechanism 30 when the housing 20 is removed from the receptacle 40 may prevent the shredding mechanism 30 from scratching or otherwise damaging this surface. The position of the flap 50 may also prevent injury to the user.

The housing 20 may also include one or more feet 76 to minimize contact between the underside of the housing and a surface such as a countertop or floor. As illustrated in FIGS. 7 and 8, the flap 50 may also include a plurality of holes 52. These holes may assist in providing air flow into the housing 20 and shredding mechanism which may assist in cooling components after use.

In one embodiment, the flap 50 is configured to be in the closed position when the handle 24 is in the second position, and the flap 50 is configured to be in the open position when the handle 24 is in the first position. In this configuration, when a user is removing the housing 20 from the receptacle 40, he/she may first move the handle 24 from the first position to the second position. Once the handle is in the second position, the user may grasp the handle 24 to remove the housing 20 from the receptacle 40. When the housing 20 is removed from the receptacle 30, the flap 50 is in the closed position covering the shredding mechanism 30. Thereafter, when the housing 20 is coupled with the receptacle 30, the handle 24 may be moved back into the first position. This movement of the handle 24 may trigger the flap 50 to move back to the open position.

In some embodiments, the flap 50 may move independently of the handle 24. For example, in one embodiment, the flap 50 may be configured to move from the closed position to the open position when the housing 20 is coupled to the receptacle 40. This may be accomplished in a variety of ways. One particular example is illustrated in FIGS. 7, 8 and 11 and is now described in greater detail. As shown in FIGS. 7 and 8, a cam 56 may be movable with the flap 50. Similar to the flap 50, the cam 56 may also be movable between at least a first position and a second position, such that when the cam 56 is in the first position the flap 50 is in the closed position (see FIG. 7). Furthermore, when the cam 56 is in its second position, the flap 50 may be in its open position (see FIG. 8).

In the embodiment illustrated, the cam 56 is located within a recess 62 which may be located on the underside of the housing 20. As illustrated, the cam 56 rotates between its first and second positions, where in the second position, the cam 56 is positioned farther into the recess 62. In one embodiment, the recess 62 is an extension of the opening 60. However, it should be appreciated that in other embodiments, the cam 56 and recess 62 may be configured differently.

The cam 56 may be configured to move with the flap 50 in a variety of ways. As shown in FIGS. 7 and 8, the two components are linked together through a hinge 54 which may extend substantially along the length of the flap 50. The cam 56 may be coupled to the hinge 54 at one end so that when the cam is rotated, the flap 50 also rotates. It should be appreciated that in other embodiments, the cam 56 and flap 50 may be configured in other ways. For example, in one embodiment, translational movement of the flap 50 and/or cam 56 with respect to the housing 20 may be present, as the invention is not limited in this respect.

In one embodiment, the housing 20 is configured such that the flap 50 is in a normally closed position, as shown in FIG. 7. This may be accomplished with a spring loaded hinge assembly, which may include a helical spring (not shown) extending about at least a portion of the hinge 54. Unless the cam 56 rotates to its second position (see FIG. 8), the flap 50 remains in its closed position, shielding the shredding mechanism 30.

As shown in FIG. 11, the receptacle 40 may be configured to contact the cam 56 and rotate the cam 56 into its second position. For example, in one embodiment, a detent 80 is positioned on the receptacle 40. As shown, the detent 80 may be formed by a rib extending out from an inside surface of the receptacle 40. The detent 80 is constructed to move the cam 56 to the second position which rotates the flap 50 to an open position when the housing 20 is coupled to the receptacle 40. In this particular embodiment, the housing 20 is coupled to the receptacle 40 when the housing 20 is placed on top of the receptacle. Therefore, the flap 50 is in its open position for shredding material once the housing is coupled to the receptacle 40. Once the housing 20 is removed from the receptacle 40, the flap 50 returns to its closed position.

FIG. 11 illustrates a receptacle 40 according to one embodiment of the present invention. As discussed above, side handles 46 may be molded into the receptacle side walls. Opposite the side handles 46, on an inside surface of the receptacle 40, a ledge 48 may be formed. In one embodiment, ledge 48 may be formed from the molding process which also forms the receptacle 40. Corresponding features 72 on the sides of the housing 20 (see FIGS. 6-8) may be formed to assist to align and couple the housing 20 on the top of the receptacle 40. The housing 20 may also include a lip 74 (see FIGS. 7 and 8) which may rest along the upper edge of the receptacle walls.

The shredding mechanism 30 may be made in a variety of ways, as the present invention is not limited to a particular type of shredding mechanism. The shredding mechanism 30 may include a plurality of cutting blades and a motor. The shredding mechanism 30 may include two rows of rotary blades where each row is spaced apart from the other and the blades in one row may mesh between blades in the opposing row. However, it should be appreciated that the present invention is not limited in this respect, as other shredding mechanisms may also be employed.

In embodiments where the shredding mechanism 30 requires connection to a power source, such as standard AC current, the receptacle 40 may include a notch 78 to accommodate a power cord extending out from the housing 20.

As shown in FIG. 1, the housing 20 may include an on/off switch 22 to control power to the shredding mechanism 30. However, as described above, in certain embodiments, the position of the handle 24 and/or the flap 50 may override the on/off switch 22 by disabling the shredding mechanism. For example, in one embodiment, when the handle 24 is in its second position and/or when the flap 50 is in its closed position, power is not supplied to the shredding mechanism. This override mechanism associated with the handle 24 and/or the flap 50 may be achieved through a variety of either mechanical or electrical approaches, and may for example be done with circuitry.

The on/off switch 22 may also include both forward and reverse features, and the reverse feature may cause the blades to rotate in the opposite direction to prevent items from becoming jammed in the shredding mechanism. An additional on/off switch 64 may be located on the underside of the housing (see FIGS. 7 and 8).

The housing may also include an indicator 26 which provides a signal to the user when the power is on. In one embodiment, the indicator 26 may include a light emitting diode (LED). In other embodiments, the indicator may include an LCD screen which provides a word, phrase, or symbol to indicate whether or not the power is on.

It should be appreciated that in certain embodiments, the handle 24 may also act as a visual indicator of whether or not power is being supplied to the shredding mechanism 30. As described above, when the handle 24 is in its second position, the shredding mechanism 30 may be disabled, thus blocking the supply of power to shredding mechanism 30. In certain embodiments, when the handle 24 is moved from its first position, the shredding mechanism is disabled. In an embodiment similar to that illustrated in FIGS. 1-3, when the handle 24 is raised from its first position, the user may be able to determine that the shredding mechanism 30 is disabled based on looking at the position of the handle 24.

The shredder 10 of the present invention may be made of different materials. In one embodiment, certain components such as the receptacle 40 and portions of the housing 20 may be made from a molded plastic material. In one embodiment, the handle 24 may include a rubberized material on at least the outer surface of the handle 24 to provide an enhanced gripping surface. However, in other embodiments, the shredder 10 may be made of other materials, and the invention is not limited in this respect.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A shredder comprising:
a shredding mechanism;
a housing at least partially enclosing the shredding mechanism;
a receptacle, to which the housing is removably coupled, that receives and contains shredded material; and
a handle coupled to the housing, the handle being movable between at least a first position and a second position with respect to the housing, wherein when the handle is in the second position, the shredding mechanism is disabled and the housing may be removed safely from the receptacle.

2. The shredder of claim 1, wherein the shredding mechanism is disabled when the handle is moved out of the first position.

3. The shredder of claim 1, wherein the handle is substantially U-shaped.

4. The shredder of claim 1, further comprising a flap positioned on a side of the housing, wherein the flap is movable between a closed position in which the flap covers the shredding mechanism and an open position in which an opening is provided between the shredding mechanism and the receptacle.

5. The shredder of claim 4, wherein the flap is configured to be in the closed position when the handle is in the second position, and the flap is configured to be in the open position when the handle is in the first position.

6. The shredder of claim 1, wherein the handle is rotatable between the first position and the second position, and the first and second positions are spaced apart approximately 90°.

7. The shredder of claim 1, wherein the housing includes a recessed portion and the handle is adapted to fit within at least a portion of the recessed portion when the handle is in the first position.

8. The shredder of claim 1, wherein the housing is adapted to fit on top of the receptacle such that at least a portion of the housing is recessed within the receptacle.

9. A shredder comprising:
a shredding mechanism;
a housing at least partially enclosing the shredding mechanism;
a receptacle, to which the housing is removably coupled, that receives and contains shredded material;
a flap positioned on a side of the housing adjacent the shredding mechanism, wherein the flap is movable between a closed position in which the flap covers the shredding mechanism and an open position in which an opening is provided between the shredding mechanism and the receptacle;
a cam movable with the flap, the cam movable between at least a first position and a second position, wherein when the cam is in the first position, the flap is in the closed position; and
a detent positioned on the receptacle, the detent constructed and arranged to move the cam to the second position when the housing is coupled to the receptacle.

10. The shredder of claim 9, wherein the detent includes a rib extending out from an inside surface of the receptacle.

11. The shredder of claim 9, wherein the cam rotates between the first position and the second position.

12. The shredder of claim 9, wherein the flap rotates between the closed position and the open position.

13. The shredder of claim 9, further comprising a handle coupled to the housing, the handle being movable between at least a first position and a second position with respect to the housing, wherein when the handle is in the second position, the shredding mechanism is disabled and the housing may be removed safely from the receptacle.

14. The shredder of claim 13, wherein the shredding mechanism is disabled when the handle is moved out of the first position.

15. The shredder of claim 9, wherein the shredding mechanism is disabled when the flap is in the closed position.

16. A shredder comprising:
a shredding mechanism;
a housing at least partially enclosing the shredding mechanism;
a receptacle, to which the housing is removably coupled, that receives and contains shredded material;
a handle, movably attached to the housing, to enable removal of the housing from the receptacle; and
a flap, movably coupled to the housing, the flap positioned to protect a user from the shredding mechanism during removal of the housing from the receptacle.

17. The shredder of claim 16, wherein the handle is movable between at least a first position and a second position with respect to the housing, wherein when the handle is in the second position, the shredding mechanism is disabled.

18. The shredder of claim 17, wherein the shredding mechanism is disabled when the handle is moved out of the first position.

19. The shredder of claim 16, further comprising:
a cam movable with the flap, the cam movable between at least a first position and a second position, wherein when the cam is in the first position, the flap is in the closed position; and
a detent positioned on the receptacle, the detent constructed and arranged to move the cam to the second position when the housing is coupled to the receptacle.

20. The shredder of claim 16, wherein the handle is rotatable between the first position and the second position, and the first and second positions are spaced apart approximately 90°.
